(19) United States
(12) Patent Application Publication
(10) Pub. No.: US 2025/0247614 A1
(43) Pub. Date: Jul. 31, 2025

(54) IMAGE CAPTURE APPARATUS AND CONTROL METHOD

(71) Applicant: CANON KABUSHIKI KAISHA, Tokyo (JP)

(72) Inventor: TAKAHIKO OYACHI, Kanagawa (JP)

(21) Appl. No.: 19/018,189

(22) Filed: Jan. 13, 2025

(30) Foreign Application Priority Data
Jan. 25, 2024 (JP) 2024-009599

(51) Int. Cl. H04N 23/661; H04N 23/63

(52) U.S. Cl. CPC H04N 23/662; H04N 23/634

(57) ABSTRACT

An image capture apparatus connects to another image capture apparatus so as to be capable of mutual communication, obtains status information regarding a state of the another image capture apparatus from the another image capture apparatus, and displays, on a display unit, a warning based on status information obtained from the another image capture apparatus in a case where an instruction for shooting preparation processing performed prior to shooting processing of a captured image is received.

### BACKGROUND OF THE INVENTION

### Field of the Invention

The present invention relates to a system in which a plurality of image capture apparatuses are interlocked to perform shooting.

### Description of the Related Art

A system is known in which a plurality of remote cameras are remotely operated by a master camera or a smartphone to interlock the master camera or the smartphone and the plurality of remote cameras, thereby enabling shooting and at the same time transmission of a shot image to a server.

According to such a system, shooting and transfer of images can be performed with a minimum number of people, so that cost can be reduced and a large number of images can be shot in various compositions (NX Field®, Remote Camera Tool (Sony Corporation)).

In such a system, a user who operates the master camera needs to perform shooting while checking the states of the remote camera such as a remaining capacity of the battery, a communication strength, an internal temperature, and a memory capacity. Japanese Patent Laid-Open No. 2001-309093 discloses a method of displaying a warning on a personal computer (PC) when a remaining capacity of the battery of the scanner decreases in a system in which the scanner is connected to the PC. Japanese Patent Laid-Open No. 2007-184943 discloses a method of detecting an abnormality from an image and displaying the image in which the abnormality is detected on the full screen in a system for displaying a plurality of television videos and camera videos on one screen.

In Japanese Patent Laid-Open No. 2001-309093 and Japanese Patent Laid-Open No. 2007-184943, it is not assumed to display the states of a plurality of cameras, and there is a possibility that the display of the state of the remote camera deteriorates operability at the time of shooting.

### SUMMARY OF THE INVENTION

The present invention has been made in consideration of the aforementioned problems, and realizes techniques of displaying a state of another image capture apparatus in such a manner that operability at the time of shooting is not deteriorated.

In order to solve the aforementioned problems, the present invention provides an image capture apparatus comprising: a communication unit that connects to another image capture apparatus so as to be capable of mutual communication; an obtaining unit that obtains status information regarding a state of the another image capture apparatus from the another image capture apparatus; and a control unit that displays, on a display unit, a warning based on status information obtained from the another image capture apparatus in a case where an instruction for shooting preparation processing performed prior to shooting processing of a captured image is received.

In order to solve the aforementioned problems, the present invention provides a method of controlling an image capture apparatus, the method comprising: connecting to another image capture apparatus so as to be capable of mutual communication; obtaining status information regarding a state of the another image capture apparatus from the another image capture apparatus; and displaying, on a display unit, a warning based on status information obtained from the another image capture apparatus in a case where an instruction for shooting preparation processing performed prior to shooting processing of a captured image is received.

According to the present invention, a state of another image capture apparatus can be displayed so as not to reduce operability at the time of shooting.

Further features of the present invention will become apparent from the following description of exemplary embodiments (with reference to the attached drawings).

### BRIEF DESCRIPTION OF THE DRAWINGS

FIG. 1 is a system configuration diagram according to the present embodiment.

FIG. 2 is a block diagram illustrating an apparatus configuration of the present embodiment.

FIG. 3 is a flowchart illustrating control processing of a master camera according to a first embodiment.

FIG. 4 is a flowchart illustrating control processing of a slave camera according to the first embodiment.

FIGS. 5A to 5C are diagrams illustrating an example of a state display of the slave camera according to the first embodiment.

FIGS. 6A to 6D are diagrams illustrating screen transition of the master camera according to the first embodiment.

FIG. 7 is a flowchart illustrating control processing of a master camera according to a second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

In the present embodiment, an example of a system in which an image capture apparatus of the present invention is applied to a digital camera that can shoot a still image or a moving image (hereinafter also referred to as an image), and a master camera communicates with a plurality of slave cameras will be described. Note that the image capture apparatus of the present invention is not limited to the digital camera, and may be a mobile device such as a smartphone or a tablet computer (PC).

In the system of the present embodiment, the master camera is a camera directly operated by the user, and a plurality of slave cameras are cameras that are disposed at positions away from the master camera and at positions that cannot be directly operated by the user and operate interlocked with the operation of the master camera. The master camera can display information (status information) regarding the state of the slave camera received from the slave camera at an appropriate timing in such a manner that the operability of the master camera at the time of shooting is not deteriorated.

### [System Configuration]

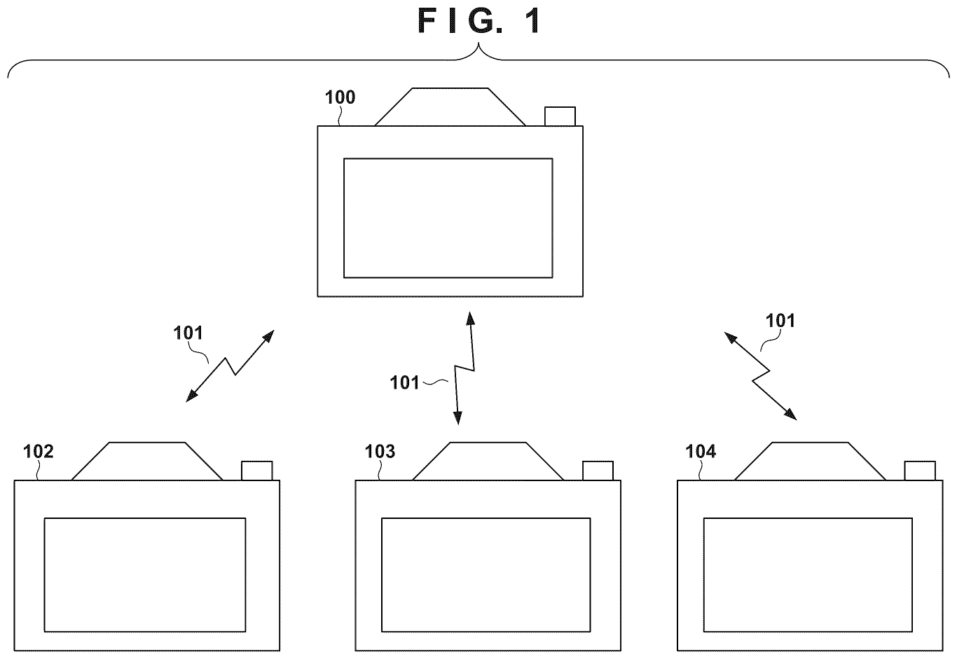

First, a system configuration of the present embodiment will be described with reference to FIG. 1.

In the system of the present embodiment, the master camera 100 and the plurality of slave cameras 102, 103, and 104 are connected via a communication path 101 so as to be capable of mutual communication. In the present embodiment, the communication method is assumed to be a wireless communication method such as a wireless local area network (LAN), but the communication method may be wired connection by a cable such as a universal serial bus (USB). A hypertext transfer protocol (HTTP) protocol or the like is used as the communication protocol, but this is not the sole case.

In the example of FIG. 1, three slave cameras 102, 103, and 104 are connected to one master camera 100, but the number of slave cameras connected to the master camera 100 is not limited to three, and may be two or less or four or more.

When the user performs a predetermined operation on the master camera 100 in a state where the connection for communication between the master camera 100 and the slave cameras 102, 103, and 104 is established, the master camera 100 transmits a command request corresponding to the predetermined operation to the slave cameras 102, 103, and 104. The slave cameras 102, 103, and 104 analyze the command request received from the master camera 100 and execute processing corresponding to the command request. For example, when the user operates the master camera 100 to give an instruction for shooting preparation processing or an instruction for shooting processing, command requests for photometry processing (automatic exposure (AE) processing and autofocus (AF) processing) with respect to a captured image, shooting processing for recording a captured image, and the like are transmitted to the slave cameras 102, 103, and 104. The slave cameras 102, 103, and 104 execute processing corresponding to the command request received from the master camera 100, and transmit a processing result to the master camera 100 as a response.

In the present embodiment, the master camera 100 and the slave cameras 102, 103, and 104 can perform interlocked shooting operations. In the present embodiment, a use case is assumed in which the slave cameras 102, 103, and 104 are arranged at positions away from the master camera 100 and at positions that cannot be directly operated by the user. In such a use case, in a case where the shooting operations of the slave cameras 102, 103, and 104 are restricted due to factors such as an insufficient remaining capacity of the battery, a decrease in communication strength or disconnection, a rise in internal temperature, and a memory shortage of the slave cameras 102, 103, and 104, the shooting result intended by the user cannot be obtained. Therefore, in the present embodiment, in order to avoid such a situation in advance, the master camera 100 obtains status information such as the remaining capacity of the battery, the communication state, the internal temperature, and the memory capacity from the slave cameras 102, 103, and 104, and displays a warning corresponding to the status information received from the slave cameras 102, 103, and 104 at an appropriate timing to notify the user in such a manner that the operability of the master camera 100 at the time of shooting is not deteriorated.

### [Apparatus Configuration]

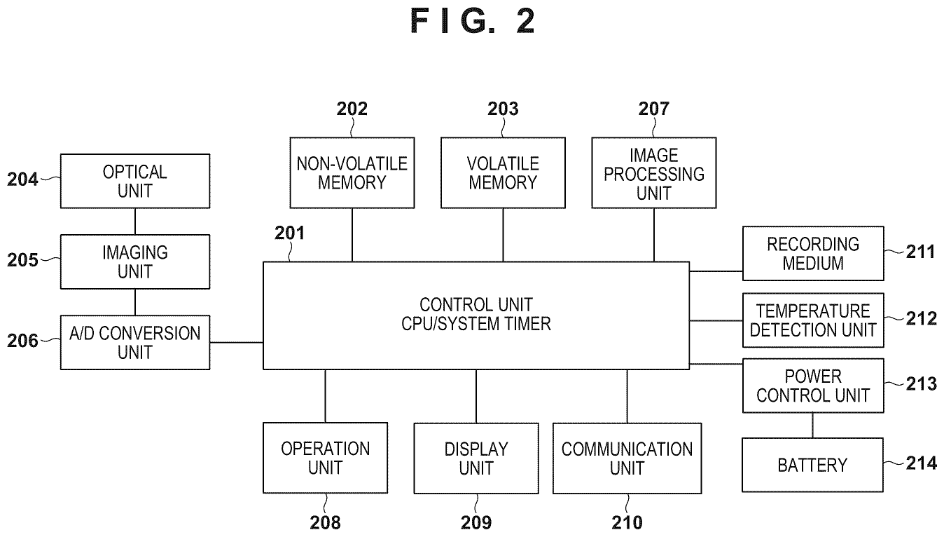

Next, configurations and functions of the master camera and the slave camera of the present embodiment will be described with reference to FIG. 2.

FIG. 2 is a block diagram illustrating configurations of a master camera and a slave camera according to the present embodiment.

The master camera 100 and the slave cameras 102, 103, and 104 (hereinafter referred to as camera 200) include a control unit 201, a non-volatile memory 202, a volatile memory 203, an optical unit 204, an imaging unit 205, an A/D conversion unit 206, an image processing unit 207, an operation unit 208, a display unit 209, a communication unit 210, a recording medium 211, a temperature detection unit 212, a power control unit 213, and a battery 214.

The control unit 201 is an arithmetic processing processor (CPU or MPU) that totally controls the entire camera 200, and controls components to be described later by executing a program stored in the non-volatile memory 202. Note that, instead of the control unit 201 controlling the entire apparatus, the entire apparatus may be controlled by sharing the processing among a plurality of units of hardware.

The control unit 201 includes a system timer that measures a time used for various types of control and a time of a built-in clock.

The non-volatile memory 202 is a ROM and is used as a storage area for storing constants, programs, and the like for operation of the control unit 201. The program is a program for executing control processing described later. In addition, the non-volatile memory 202 stores setting information at the time of shooting of the camera 200 and a threshold for each piece of status information for determining whether or not to restrict the operation of the camera 200. The status information includes the remaining capacity of the battery, the internal temperature, and a radio wave intensity of the camera 200.

The volatile memory 203 is a RAM, and is used as a work area for developing constants and variables for operation of the control unit 201, programs read from the non-volatile memory 202, and the like. In addition, the volatile memory 203 is also used as a buffer memory that temporarily saves image data and the like captured by the imaging unit 205 described later.

The optical unit 204 includes a lens group including a zoom lens or a focus lens, and a shutter having a diaphragm function.

The imaging unit 205 includes an image sensor including a CCD, a CMOS, or the like that converts the optical image of the subject formed by the optical unit 204 into an electrical signal. The imaging unit 205 generates still image data and moving image data formed of an analog signal.

The A/D conversion unit 206 converts the analog signal generated by the imaging unit 205 into a digital signal. The A/D conversion unit 206 generates still image data or moving image data formed of a digital signal from still image data or moving image data formed of an analog signal.

The image processing unit 207 executes various types of image processing on the image data output from the A/D conversion unit 206. The image processing unit 207 compression-encodes still image data subjected to image processing in a JPEG format or the like, or encodes moving image data in a moving image compression scheme such as an MP4 format to generate an image file, and records the image file in the recording medium 211. Furthermore, the image processing unit 207 decodes a still image file read from the recording medium 211, and decodes a moving image file read from the recording medium 211.

Furthermore, the control unit 201 performs AE processing and AF processing by controlling the optical unit 204 based on a result of performing predetermined arithmetic processing using the image data subjected to image processing.

Note that the image processing unit 207 may include a dedicated circuit block (graphical processing unit (GPU)) for executing specific image processing.

The operation unit 208 is an operation member such as a switch, a button, or a touch panel that accepts various operations from a user, and notifies the control unit 201 of the operations. The operation unit 208 includes at least a still image shooting button, a moving image shooting button, a mode dial, and a power switch.

The still image shooting button is an operation member for instructing the control unit 201 to perform shooting processing of a still image. The moving image shooting button is an operation member for instructing the control unit 201 to perform shooting processing of a moving image.

The mode dial is an operation member for switching an operation mode of the camera 200. The mode dial can switch the operation mode of the camera 200 to any of a still image shooting mode, a moving image shooting mode, and a reproduction mode.

The power switch is an operation member for switching on/off of the power of the camera 200.

When the still image shooting button is half-pressed, the control unit 201 is notified of an instruction for shooting preparation processing. In the still image shooting mode, when the still image shooting button is half-pressed, the control unit 201 starts the shooting preparation processing (AE processing and AF processing) of a still image. When the still image shooting button is fully pressed, the control unit 201 is notified of an instruction for shooting processing. When the still image shooting button is fully pressed, the control unit 201 executes still image shooting processing of recording the image data captured by the imaging unit 205 on the recording medium 211. Note that the shooting preparation processing is not limited to the case where the still image shooting button is half-pressed, and there is also a case where at least one of the AE processing and the AF processing is executed by operating an operation member for AE or an operation member for AF different from the still image shooting button included in the operation unit 208.

Furthermore, in the moving image shooting mode, the control unit 201 performs the shooting preparation processing (AE processing and AF processing) on the image data (frame) captured by the imaging unit 205 in response to the moving image shooting button being pressed first, continues the moving image shooting processing of recording a moving image for a predetermined time on the recording medium 211, and stops the moving image shooting processing in response to the moving image shooting button being pressed again.

The display unit 209 displays image data (live view) captured by the imaging unit 205, displays image data read from the recording medium 211, displays a graphical user interface (GUI) for interactive operation, and the like. The display unit 209 includes, for example, a display device such as a liquid crystal display or an organic EL display.

The communication unit 210 is connected to an external apparatus so as to be capable of mutual communication by a wireless antenna or a wired cable, and transmits and receives various types of information. The communication unit 210 can also be connected to a wireless local area network (LAN) or the Internet. The various types of information include a command request transmitted from the master camera to the slave camera, status information transmitted from the slave camera to the master camera, and the like. Furthermore, the communication unit 210 detects a communication state such as radio wave intensity of the wireless LAN. The status information regarding the communication state detected by the communication unit 210 is output to the control unit 201. The control unit 201 performs control to continue, restrict, or end the current operation mode of the camera 200 based on the status information regarding the communication state detected by the communication unit 210. For example, when the disconnection state is detected as the communication state of the camera 200, the control unit 201 displays a warning on the display unit 209 or forcibly ends the shooting operation.

The recording medium 211 is a memory card, a hard disk, or the like, and records an image file or the like generated by the image processing unit 207. The control unit 201 reads data from the recording medium 211 and writes data to the recording medium 211.

The temperature detection unit 212 includes, for example, a thermistor or a digital thermometer that measures temperature, and detects the internal temperature of the camera 200. The status information regarding the internal temperature detected by the temperature detection unit 212 is output to the control unit 201. The control unit 201 performs control to continue, restrict, or stop the current operation mode of the camera 200 based on the status information regarding the internal temperature detected by the temperature detection unit 212. For example, when the internal temperature of the camera 200 reaches the limit temperature, the control unit 201 displays a warning on the display unit 209 or forcibly ends the shooting operation.

The power control unit 213 detects whether the battery is attached, the type of the battery, and the remaining capacity of the battery. Furthermore, the power control unit 213 supplies a necessary voltage to each component including the recording medium 211 for a necessary period. The status information regarding the remaining capacity of the battery detected by the power control unit 213 is output to the control unit 201. The control unit 201 performs control to continue, restrict, or end the operation mode of the camera 200 based on the status information regarding the remaining capacity of the battery detected by the power control unit 213. For example, when the remaining capacity of the battery of the camera 200 reaches the threshold voltage, the control unit 201 displays a warning on the display unit 209 or forcibly ends the shooting operation.

The battery 214 is a primary battery such as an alkaline battery or a lithium battery, or a secondary battery such as a NiCd battery, a NiMH battery, or a lithium-ion battery.

The control unit 201 of the master camera 100 performs control corresponding to an instruction received from the operation unit 208, control to display an image or a GUI on the display unit 209, communication control with the slave cameras 102, 103, and 104 by the communication unit 210, and the like. Furthermore, the control unit 201 of the master camera 100 generates data to be transmitted to the slave cameras 102, 103, and 104, displays a warning corresponding to status information received from the slave cameras 102, 103, and 104, and the like.

The control unit 201 of the slave cameras 102, 103, and 104 performs communication control with the master camera 100 by the communication unit 210, control corresponding to a command request received from the master camera 100, generation of data to be transmitted to the master camera 100, and the like.

In the present embodiment, the control unit 201 of the master camera 100 transmits a command request for shooting preparation processing or shooting processing to the slave cameras 102, 103, and 104 when an instruction for shooting preparation processing or shooting processing is received from the operation unit 208 according to a user operation.

The control unit 201 of the slave cameras 102, 103, and 104 executes processing corresponding to the command request received from the master camera 100, and transmits a processing result as a response to the master camera 100. Furthermore, when the command request for the shooting preparation processing is received from the master camera 100, the control unit 201 of the slave cameras 102, 103, and 104 transmits the processing result of the command request and the status information of the slave cameras 102, 103, and 104 to the master camera 100.

Note that the slave cameras 102, 103, and 104 can be remotely controlled by the master camera 100 and can transmit images to the master camera 100, and thus may not necessarily include the operation unit 208 and the display unit 209.

### [Control Processing]

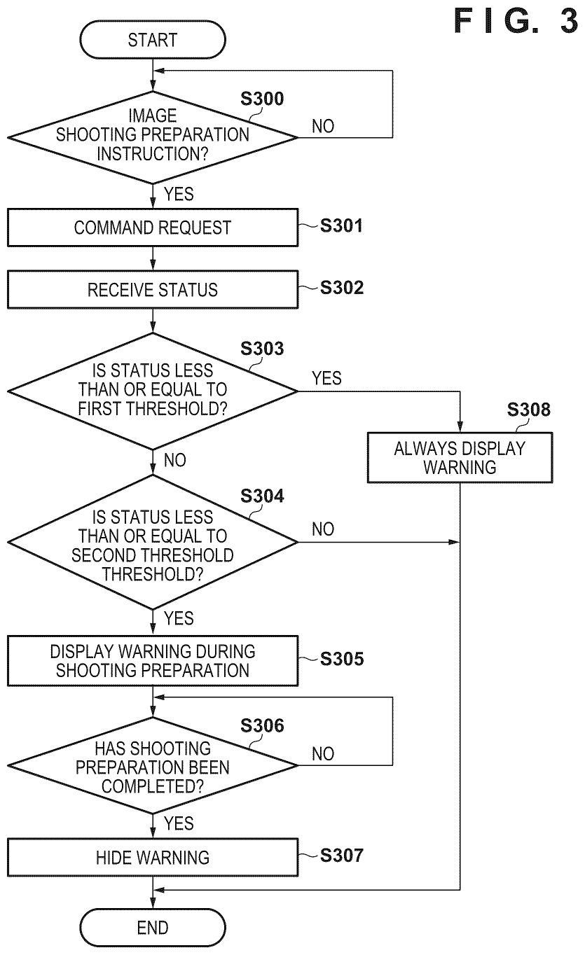

Next, control processing of the first embodiment will be described with reference to FIGS. 3 to 6D.

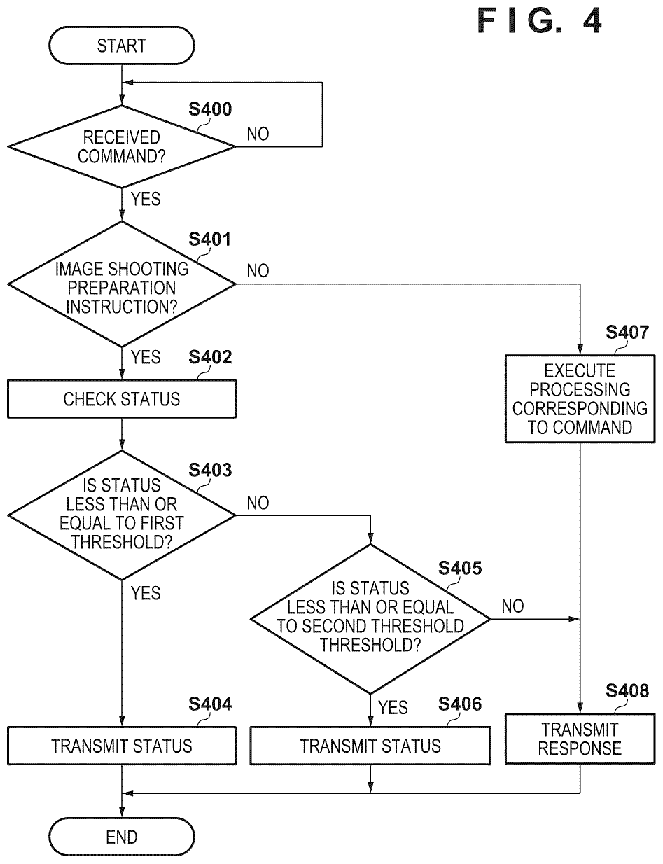

FIG. 3 is a flowchart illustrating control processing of the master camera 100. FIG. 4 is a flowchart illustrating control processing of the slave cameras 102, 103, and 104.

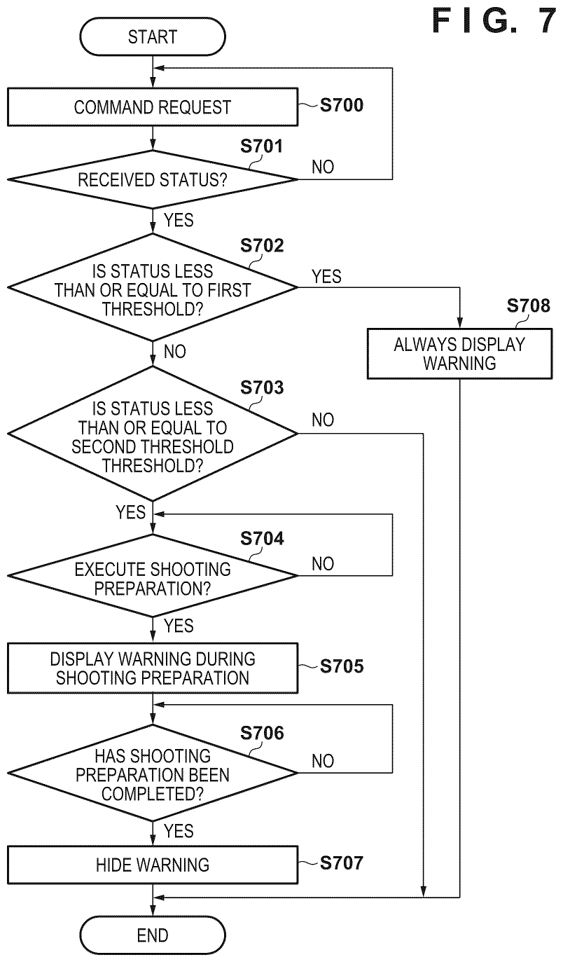

The processing in FIGS. 3 and 4 will be described using the master camera 100 or the slave cameras 102, 103, and 104 as the operation subject for simplification of description, but the control unit 201 of the master camera 100 or the slave cameras 102, 103, and 104 is actually the operation subject. Specifically, the processing of FIG. 3 is realized by the control unit 201 of the master camera 100 executing a program stored in the non-volatile memory 202 and controlling each component of the master camera 100. Furthermore, the processing of FIG. 4 is realized by the control unit 201 of the slave cameras 102, 103, and 104 executing a program stored in the non-volatile memory 202 and controlling each component of the slave cameras 102, 103, and 104. The same applies to FIG. 7 to be described later.

Furthermore, the processing in FIGS. 3 and 4 is started in a state in which the operation modes of the master camera 100 and the slave cameras 102, 103, and 104 are the still image shooting mode and connection is established in advance. The same applies to FIG. 7 to be described later.

In step S300, the master camera 100 waits until receiving an instruction for the shooting preparation processing via the operation unit 208. Upon determining that the instruction for the shooting preparation processing has been received, the master camera 100 proceeds the processing to step S301.

In step S301, the master camera 100 transmits a command request for shooting preparation processing to the slave cameras 102, 103, and 104 via the communication unit 210.

In step S302, the master camera 100 receives, as a response to the command request transmitted in step S301, a processing result corresponding to the command request from the slave cameras 102, 103, and 104. The responses of the slave cameras 102, 103, and 104 may or may not include status information of the slave cameras 102, 103, and 104 as described later with reference to FIG. 4.

In step S303, the master camera 100 determines whether or not the status information of the slave camera received in step S302 is a first threshold or less. Upon determining that the status information is the first threshold or less, the master camera 100 proceeds the processing to step S308. Upon determining that the status information exceeds the first threshold, the master camera 100 proceeds the processing to step S304. The first threshold is set to a level at which it is determined that the state of the slave camera corresponding to the status information to be determined needs to be urgently improved and the shooting operation will be restricted or terminated if the state is not improved.

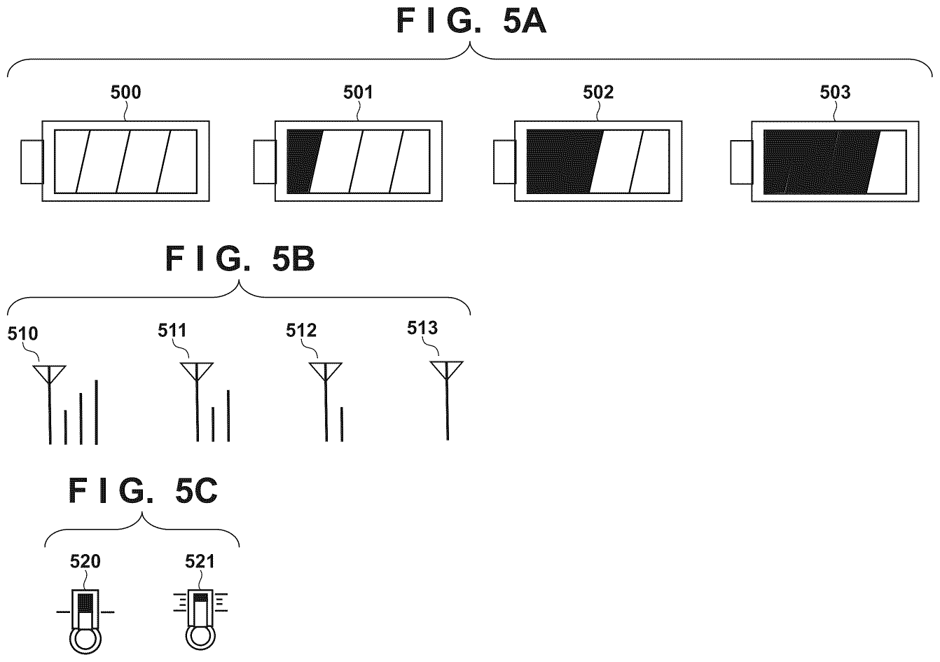

Here, the status information of the slave cameras 102, 103, and 104 and the threshold of the status information will be described with reference to FIG. 5A thru 5C.

FIG. 5A illustrates the status information related to a remaining capacity of the battery. A first battery icon 500 corresponds to status information of a state in which the battery is fully charged. A second battery icon 501 corresponds to status information of a state in which the remaining capacity of the battery is decreasing but is still sufficient. The third battery icon 502 corresponds to status information of a state in which the remaining capacity of the battery is decreasing. A fourth battery icon 503 corresponds to status information of a state in which the remaining capacity of the battery is decreased to the minimum level and is immediately before becoming zero. When the status information is the remaining capacity of the battery, the first threshold corresponds to the status information of the state of the fourth battery mark 503.

FIG. 5B illustrates status information related to a communication state. A first communication icon 510 corresponds to status information of a state in which the communication strength is the highest and stable communication is possible. A second communication icon 511 corresponds to status information of a state in which the communication strength is an intermediate level between the highest and the lowest communication strength, and is sufficient for performing communication. A third communication icon 512 corresponds to status information of a state in which the communication strength has deteriorated and the communication state has deteriorated. A fourth communication icon 513 corresponds to status information of a state in which the communication strength is the lowest and there is a high possibility that communication cannot be performed. When the status information is the communication state, the first threshold corresponds to the status information of the state of the fourth communication icon 513.

FIG. 5C illustrates status information related to an internal temperature. The temperature icon indicates a possibility that shooting is restricted due to a temperature rise. A first temperature icon 520 corresponds to status information of a state in which the internal temperature of the camera is rising and the image quality of the shot image may be affected but shooting is possible. A second temperature icon 521 corresponds to status information of a state in which the internal temperature of the camera is high and shooting will be automatically terminated soon. When the status information is the internal temperature, the first threshold corresponds to the status information of the state of the second temperature icon 521, and a numerical value such as the number of images that can be shot is the threshold. For example, the number of images that can be shot is 100 or less is set as the first threshold.

Note that the status information and the threshold in FIGS. 5A through 5C are examples, and can be changed by a user or a system.

Returning to FIG. 3, in step S304, since the status information of the slave camera received in step S302 is not the first threshold or less, the master camera 100 determines that improvement is urgently needed, and if the improvement is not made, it is a level at which the shooting operation is to be restricted or terminated. The master camera 100 determines whether or not the status information of the slave camera received in step S302 is a second threshold (>first threshold) or less. Upon determining that the status information is the second threshold or less, the master camera 100 proceeds the processing to step S305. Upon determining that the status information exceeds the second threshold, the master camera 100 determines that the slave camera corresponding to the status information to be determined is not in an abnormal state in which the shooting operation is to be restricted or terminated, and terminates the processing.

In the example of FIGS. 5A through 5C, the second threshold is the state of the third battery icon 502 when the status information is the remaining capacity of the battery, the state of the third communication icon 512 when the status information is the communication state, the state of the first temperature icon 520 when the status information is the internal temperature, and 500 or less when it is the number of images that can be shot.

In step S305, the master camera 100 displays a warning corresponding to the status information of the slave camera received in step S302 on the display unit 209 during the shooting preparation.

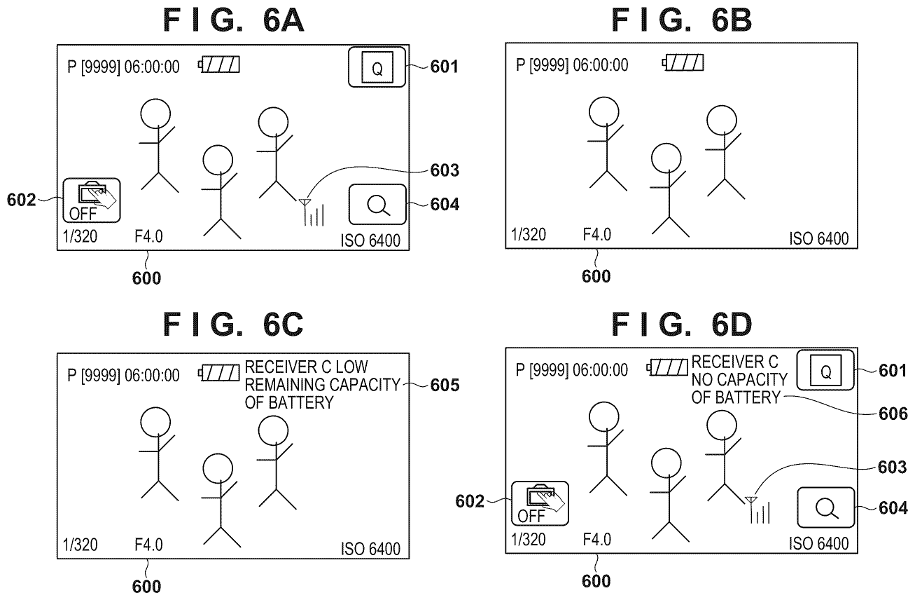

Here, a display example of the warning corresponding to the status information of the slave cameras 102, 103, and 104 by the master camera 100 will be described with reference to FIGS. 6A through 6D.

FIG. 6A illustrates a live view screen 600 displayed on the display unit 209 of the master camera 100. FIG. 6A illustrates a state in which images in which three people are captured by the imaging unit 205 are displayed in real time. A button 601 is an operation member for switching the setting so as to display detailed information on the live view screen 600. The user can display detailed information regarding shooting by touching the button 601. A button 602 is an operation member for switching the touch release function to enable or disable. The touch release function is a function in which shooting is executed in response to the user touching the live view screen 600. The communication icon 603 corresponds to the communication icon corresponding to the status information described with reference to FIG. 5B. The user can ascertain the communication strength by looking at the communication icon and determine that communication is possible. The button 604 is an operation member for enlarging an image. The user can enlarge the image displayed on the live view screen 600 by touching the button 604. For example, the display can be switched to the 5-magnification display by the first touch of the button 604, the display can be switched to the 10-magnification display by the second touch, and the display can be returned to the equal magnification display by the third touch.

FIG. 6B illustrates a live view screen 600 displayed on the display unit 209 when the master camera 100 receives an instruction for shooting preparation processing from the operation unit 208. Upon receiving an instruction for the shooting preparation processing from the operation unit 208, the master camera 100 executes the shooting preparation operation and at the same time hides information unnecessary for the shooting preparation operation. In the present embodiment, the buttons 601, 602, and 604 and the communication icon 603 described in FIG. 6A are hidden.

FIG. 6C illustrates a state in which the master camera 100 transmits a command request for shooting preparation processing to the slave cameras 102, 103, and 104, and displays a warning corresponding to the status information received from the slave cameras 102, 103, and 104. In the example of FIG. 6C, information 605 indicating that the remaining capacity of the battery of the slave camera named receiver C has decreased is displayed. In step S305, the live view screen 600 in FIG. 6C is displayed on the display unit 209.

In step S306, the master camera 100 waits until the shooting preparation operation is completed. Upon determining that the shooting preparation operation has been completed, the master camera 100 proceeds the processing to step S307.

In step S307, after the shooting preparation is completed in step S306, the master camera 100 returns the live view screen 600 displayed on the display unit 209 from the state of FIG. 6C to the state of FIG. 6A, and hides the information 605.

In step S308, the master camera 100 determines that the status information of the slave camera received in step S303 is the first threshold or less, the state of the slave camera needs to be urgently improved, and if the state is not improved, it is a level at which the shooting operation is to be restricted or terminated. In the example of FIGS. 5A through 5C, in a case where the status information is the first threshold or less, it is the state of the fourth battery icon 503 when the status information is the remaining capacity of the battery, the state of the fourth communication icon 513 when the status information is the communication state, and the state of the second temperature icon 521 when the status information is the internal temperature. The master camera 100 constantly displays information necessary for prompting the user to improve the state at a location different from the display region of the information 605 on the live view screen 600 in FIG. 6C, regardless of whether or not the shooting preparation is in progress. In the example of FIG. 6D, information 606 indicating that there is no remaining capacity of the battery of the slave camera named receiver C is displayed at a location different from the display region of the information 605 of the live view screen 600 in FIG. 6A.

Next, control processing of the slave cameras 102, 103, and 104 will be described with reference to FIG. 4.

In step S400, the slave cameras 102, 103, and 104 wait until receiving a command request from the master camera 100. Upon determining that the command request has been received, the slave camera 102, 103, and 104 proceeds the processing to step S401.

In step S401, the slave cameras 102, 103, and 104 analyze the command request received from the master camera 100. Upon determining that the command request is the shooting preparation processing, the slave cameras 102, 103, and 104 proceed the processing to step S402. Upon determining that the command request is not the shooting preparation processing, the slave cameras proceed the processing to step S407.

In step S402, the slave cameras 102, 103, and 104 confirm the status information.

In step S403, the slave cameras 102, 103, and 104 determine whether or not the status information confirmed in step S402 is the first threshold or less. The slave cameras 102, 103, and 104 proceed the processing to step S404 upon determining that the status information is the first threshold or less, and proceeds the processing to step S405 upon determining that the status information exceeds the first threshold. The first threshold is as described in step S303 of FIG. 3.

In step S404, the slave cameras 102, 103, and 104 notify the master camera 100 of the status information of the first threshold or less. The slave cameras 102, 103, and 104 notify the status information and the name of each camera as a response to the command request received in step S400.

In step S405, the slave cameras 102, 103, and 104 determine that since the status information confirmed in step S402 is not less than or equal to the first threshold, it not at a level at which the shooting operation is to be restricted or terminated. The slave cameras 102, 103, and 104 determine whether or not the status information confirmed in step S402 is less than or equal to a second threshold (>first threshold). Upon determining that the status information is less than or equal to the second threshold, the slave cameras 102, 103, and 104 proceed the processing to step S406. Upon determining that the status information exceeds the second threshold, the slave cameras 102, 103, and 104 determine that the slave cameras 102, 103, and 104 are not in an abnormal state in which the shooting operation is to be restricted or terminated, and proceed the processing to step S408. The second threshold is as described in step S304 of FIG. 3.

In step S406, the slave cameras 102, 103, and 104 determine that the status information confirmed in step S402 does not need to be urgently improved, but there is a possibility that the shooting operation will be restricted or terminated in the near future. The slave cameras 102, 103, and 104 notify the master camera 100 of the status information of less than or equal to the first threshold. The slave cameras 102, 103, and 104 notify the status information and the name of each camera as a response to the command request received in step S400.

In step S407, the slave cameras 102, 103, and 104 execute processing other than the shooting preparation corresponding to the command request received in step S400. For example, when an image obtaining request is received from the master camera 100, the slave cameras 102, 103, and 104 read an image file from the recording medium 211 and transmit the image file to the master camera 100.

In step S408, the slave cameras 102, 103, and 104 determine that they are not in an abnormal state in which the shooting operation is to be restricted or terminated, do not notify the status information and the name of each camera as a response to the command request received in step S400, transmit a processing result of the command request, and terminate the processing. In a second embodiment to be described later, when the command request received from the master camera 100 is a command request for requesting the slave cameras 102, 103, and 104 to transmit status information, the status information and the name of each camera are notified as a response to the command request.

According to the first embodiment described above, in a case where the master camera 100 receives an instruction for the shooting preparation processing, the master camera displays a warning corresponding to the status information during the shooting preparation processing in a case where the state of the slave cameras 102, 103, and 104 needs to be urgently improved and, if not improved, it is not at a level at which the shooting operation is to be restricted or terminated. As a result, it is possible to display a warning corresponding to the status information received from the slave cameras 102, 103, and 104 at an appropriate timing and notify the user so as not to deteriorate the operability at the time of shooting of the master camera 100. In addition, when the state of the slave cameras 102, 103, and 104 needs to be urgently improved and, if not improved, it is at a level at which the shooting operation is to be restricted or terminated, the master camera 100 always displays a warning corresponding to the status information regardless of whether or not the shooting preparation processing is in progress. As a result, it is possible to notify the user that the state of the slave cameras 102, 103, and 104 needs to be urgently improved.

### Second Embodiment

Next, the second embodiment will be described with reference to FIG. 7.

Configurations and communication schemes of the master camera 100 and the slave cameras 102, 103, and 104 of the second embodiment are similar to those of the first embodiment. Furthermore, the control processing of the slave cameras 102, 103, and 104 of the second embodiment is similar to that in FIG. 4 of the first embodiment.

In the second embodiment, an example will be described in which the master camera 100 receives status information from the slave cameras 102, 103, and 104 at predetermined time intervals, and displays a warning corresponding to the status information received from the slave cameras 102, 103, and 104 when an instruction for shooting preparation processing is received.

In the first embodiment, the master camera 100 transmits a command request for the shooting preparation processing to the slave cameras 102, 103, and 104 when an instruction for the shooting preparation processing is received. On the other hand, in the second embodiment, the master camera 100 transmits a command request for requesting transmission of status information to the slave cameras 102, 103, and 104 regardless of whether an instruction for the shooting preparation processing has been received.

In step S700, the master camera 100 transmits a command request for requesting transmission of status information to the slave cameras 102, 103, and 104.

In step S701, the master camera 100 determines whether or not status information has been received from the slave cameras 102, 103, and 104 as a response to the command request transmitted in step S700. Upon determining that the status information has been received from the slave cameras 102, 103, and 104, the master camera 100 proceeds the processing to step S702. Upon determining that the status information has not been received from the slave cameras 102, 103, and 104, the master camera 100 returns the processing to step S700. The master camera 100 transmits a command request for requesting transmission of status information to the slave cameras 102, 103, and 104 again at predetermined time intervals.

In steps S702 and S703, the master camera 100 compares the status information received from the slave cameras 102, 103, and 104 in step S701 with the first threshold and the second threshold, similarly to steps S303 and S304 in FIG. 3.

Upon determining that the status information received from the slave cameras 102, 103, and 104 is less than or equal to the first threshold, the master camera 100 proceeds the processing to step S708. Upon determining that the status information received from the slave cameras 102, 103, and 104 exceeds the first threshold, the master camera 100 proceeds the processing to step S703.

Furthermore, upon determining that the status information received from the slave cameras 102, 103, and 104 in step S701 is less than or equal to the second threshold, the master camera 100 proceeds the processing to step S704. Upon determining that the status information received from the slave cameras 102, 103, and 104 exceeds the second threshold, the master camera 100 determines that the slave cameras 102, 103, and 104 are not in an abnormal state in which the shooting operation is to be restricted or terminated, and terminates the processing.

In step S704, the master camera 100 waits until receiving an instruction for the shooting preparation processing via the operation unit 208. Upon determining that the instruction for the shooting preparation processing has been received, the master camera 100 proceeds the processing to step S705.

In step S705, as in step S305 in FIG. 3, the master camera 100 displays a warning corresponding to the status information of the slave camera received in step S701 on the display unit 209 during shooting preparation. The warning display corresponding to the status information of the slave cameras 102, 103, and 104 by the master camera 100 is as described in FIGS. 6A through 6D.

The processing in steps S706, S707, and S708 is similar to the processing in steps S306, S307, and S308 in FIG. 3.

According to the second embodiment described above, the master camera 100 receives the status information from the slave cameras 102, 103, and 104 at predetermined time intervals regardless of the presence or absence of the instruction for the shooting preparation processing. Then, the master camera 100 displays a warning corresponding to the status information during the shooting preparation processing when the state of the slave cameras 102, 103, and 104 needs to be urgently improved in a case where the instruction for the shooting preparation processing is received, and if not improved, it is not at a level at which the shooting operation is to be restricted or terminated. As a result, it is possible to display a warning corresponding to the status information received from the slave cameras 102, 103, and 104 at an appropriate timing and notify the user so as not to deteriorate the operability at the time of shooting of the master camera 100. In addition, when the state of the slave cameras 102, 103, and 104 needs to be urgently improved and, if not improved, it is at a level at which the shooting operation is to be restricted or terminated, the master camera 100 always displays a warning corresponding to the status information regardless of whether or not the shooting preparation processing is in progress. As a result, it is possible to notify the user that the state of the slave cameras 102, 103, and 104 needs to be urgently improved.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-009599, filed Jan. 25, 2024 which is hereby incorporated by reference herein in its entirety.

What is claimed is:

1. An image capture apparatus comprising:
a communication unit that connects to another image capture apparatus so as to be capable of mutual communication;
an obtaining unit that obtains status information regarding a state of the another image capture apparatus from the another image capture apparatus; and
a control unit that displays, on a display unit, a warning based on status information obtained from the another image capture apparatus in a case where an instruction for shooting preparation processing performed prior to shooting processing of a captured image is received.

2. The apparatus according to claim 1, further comprising:
an acceptance unit that accepts a user operation; and
a transmission unit that transmits a command request for requesting processing corresponding to the user operation to the another image capture apparatus; wherein
the transmission unit transmits a command request for the shooting preparation processing to the another image capture apparatus when the acceptance unit receives the instruction for the shooting preparation processing, and
the obtaining unit obtains status information from the another image capture apparatus as a response to the command request for the shooting preparation processing.

3. The apparatus according to claim 1, further comprising:
a transmission unit that transmits a command request for requesting transmission of status information to the another image capture apparatus at a predetermined time interval, wherein
the obtaining unit obtains status information from the another image capture apparatus as a response to the command request.

4. The apparatus according to claim 1, wherein
the control unit displays the warning according to a result of comparison between the status information and a threshold.

5. The apparatus according to claim 4, wherein
when the status information is less than or equal to a first threshold, the control unit displays a first warning regardless of an instruction for the shooting preparation processing.

6. The apparatus according to claim 5, wherein
the control unit displays a second warning until a shooting preparation operation is completed when the status information is less than or equal to a second threshold larger than the first threshold.

7. The apparatus according to claim 1, wherein
the captured image and information other than the image are displayed on the display unit, and
in a case where the instruction for the shooting preparation processing is received, the control unit hides information unnecessary for the shooting preparation operation, and displays the warning at a location where the information is hidden.

8. The apparatus according to claim 7, wherein
the shooting preparation operation includes photometry processing and autofocus processing of a captured image.

9. The apparatus according to claim 1, wherein
the status information includes at least one of a remaining capacity of a battery, a number of images that can be shot, an internal temperature, and a communication state of the another image capture apparatus.

10. The apparatus according to claim 1, wherein
the another image capture apparatus transmits status information and a name of the another image capture apparatus according to a result of comparison between the status information and a threshold.

11. The apparatus according to claim 10, wherein
when the status information is less than or equal to a threshold, the another image capture apparatus transmits the status information less than or equal to the threshold and a name of the another image capture apparatus, and
when the status information exceeds the threshold, the status information and the name are not transmitted.

12. The apparatus according to claim 6, wherein
the first warning is displayed in a case where the state of the another image capture apparatus needs to be urgently improved and, if not improved, there is a possibility that the shooting operation is to be restricted or terminated, and
the second warning is displayed in a case where the state of the another image capture apparatus does not need to be urgently improved, but there is a possibility that the shooting operation is to be restricted or terminated in the near future.

13. A method of controlling an image capture apparatus, the method comprising:
connecting to another image capture apparatus so as to be capable of mutual communication;
obtaining status information regarding a state of the another image capture apparatus from the another image capture apparatus; and
displaying, on a display unit, a warning based on status information obtained from the another image capture apparatus in a case where an instruction for shooting preparation processing performed prior to shooting processing of a captured image is received.

14. A non-transitory computer-readable storage medium storing a program for causing a computer to function as an image capture apparatus comprising:
a communication unit that connects to another image capture apparatus so as to be capable of mutual communication;
an obtaining unit that obtains status information regarding a state of the another image capture apparatus from the another image capture apparatus; and
a control unit that displays, on a display unit, a warning based on status information obtained from the another image capture apparatus in a case where an instruction for shooting preparation processing performed prior to shooting processing of a captured image is received.
